(19) United States
(12) Patent Application Publication
(10) Pub. No.: US 2011/0140488 A1
(43) Pub. Date: Jun. 16, 2011

(54) SEAT ASSEMBLY FOR A VEHICLE

(76) Inventors: Brandon S. Marriott, Greensboro, NC (US); Bradley M. Glance, Dexter, MI (US)

(21) Appl. No.: 12/637,270

(22) Filed: Dec. 14, 2009

(51) Int. Cl. B60N 2/427; B60N 2/42

(52) U.S. Cl. 297/216.13

(57) ABSTRACT

A seat assembly for a vehicle comprises a seat bottom and a seat back rotatably coupled to the seat bottom. The seat bottom can selectively rotate about a rotational axis in forward rotation for absorbing energy from an impact of an occupant seated behind the seat back striking the seat back from behind. An extension is fixed relative to the seat back is spaced about the rotational axis from the seat back and a member is coupled to the extension and to the seat bottom. The extension selectively supports the seat back in the upright position. The extension is deformable relative to the member when the seat back rotates in the forward rotation so that the extension deforms to absorb energy in forward rotation.

### BACKGROUND OF THE INVENTION

1. Field of the Invention

The subject invention generally relates to a seat assembly for a vehicle, and more specifically an energy absorbing seat assembly.

2. Description of the Related Art

School buses include a seat assembly for transporting occupants and, more specifically, school buses incorporate several seat assemblies into the school bus in rows. The seat assembly includes a seat bottom extending generally horizontally and a seat back coupled to the seat bottom and extending generally vertically relative to the seat bottom. Typically, the occupants are free to move about the school bus without being restrained in the seat assembly. In other words, the occupants are not buckled into seatbelts that restrain movement of the occupants.

When a bus not equipped with seatbelts is abruptly stopped, such as during a collision, unbelted occupants typically uncontrollably move under their own momentum relative to the seat assembly. Current safety requirements, such as National Highway Transportation Safety Administration's (NHTSA) Federal Motor Vehicle Safety Standards (FMVSS) and specifically FMVSS 222, require that the seat back collapses, i.e., rotates from an upright position forward or rearward to absorb energy from an occupant to reduce impact forces between the occupant and the seat back. For this reason, in seat assemblies that do not include seatbelts, during a front-end collision, the seat back typically folds forward when the occupant uncontrollably moves forward and hits the seat back such that the seat assembly absorbs energy from the uncontrollably moving occupant. Such an arrangement is referred to in industry as compartmentalized seating. Also, the seat back typically folds rearward when the occupant seated in the seat assembly collides with the seat back during a rear-end collision or during rebound after a front-end collision.

Recently a longstanding debate as to whether school buses should be equipped with seatbelts has intensified and, as a result, more and more school buses are now being equipped with seatbelt assemblies. Public pressure is building to require all school buses be equipped with seatbelt assemblies. A strong consensus has already developed requiring the seatbelt assemblies include a lap/shoulder belt combination similar to designs now installed in most modern automobiles.

In a vehicle, a seatbelt assembly is often mounted to the seat back and the seat back remains stationary relative to the vehicle in order for the seatbelt to properly lock and restrain the occupant. However, in such a configuration, the benefits of the compartmentalized seating required by FMVSS 222 for school buses are lost, i.e., the seat back does not controllably collapse to absorb energy when an occupant strikes the seat back. Because school buses are often used to transport children, it is foreseeable that some children will buckle their seatbelts while some other children will forget or refuse to buckle their seatbelts.

Accordingly, it would be advantageous to develop a seat assembly that absorbs energy when occupants collide with the seat back during front-end and rear-end vehicle collisions while also providing adequate support for the seatbelt assembly in the upright position such that the seatbelt assembly properly functions when the occupant is buckled into the seatbelt.

### SUMMARY OF THE INVENTION AND ADVANTAGES

A seat assembly for a vehicle comprises a seat bottom. A seat back is coupled to the seat bottom and is rotatable relative to the seat bottom about a rotational axis in forward rotation from an upright position toward the seat bottom for absorbing energy from an impact of an occupant seated behind the seat back striking the seat back from behind. An extension is fixed relative to the seat back is spaced about the rotational axis from the seat back. A member is coupled to the extension and to the seat bottom and selectively supports the seat back in the upright position. The extension is deformable relative to the member when the seat back rotates in the forward rotation so that the extension deforms to absorb energy in the forward rotation.

The member advantageously controls rotation of the seat back relative to the seat bottom. When no loads are applied to the seat back, the member maintains the seat back in the upright position. The seat back can rotate from the upright position to the forward position to absorb energy from an occupant who uncontrollably moves forward and strikes the seat back from behind. The extension deforms as the seat back rotates from the upright position in forward rotation. Because the extension is fixed relative to the seat back, the deformation of the extension absorbs energy to lessen the impact of the occupant.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is FIG. 1 is a perspective view of several seat assemblies mounted in rows to a floor of a vehicle;

FIG. 2 is a perspective view of a seat assembly including a seat bottom and a seat back;

FIG. 3 is a perspective view of a portion of the seat assembly with some components removed to illustrate interior components;

FIG. 4 is another perspective view of a portion of the seat assembly with additional components removed to illustrate other interior components;

FIG. 5 is a perspective fragmented view of a portion of the seat assembly with a seat pan exploded away from a bottom frame;

FIG. 6 is a front view of the seat assembly configured in a two passenger configuration;

FIG. 7 is a front view of the seat assembly configured in a three passenger configuration;

FIG. 8 is a perspective view of a portion of the seat assembly including a first embodiment of an energy absorbing apparatus;

FIG. 9 is a perspective view of a member of the first embodiment of the energy absorbing apparatus;

FIG. 10 is a cross-sectional view of the seat assembly along line A-A of FIG. 2 including the first embodiment of the energy absorbing apparatus when the seat back is in an upright position;

FIG. 11 is a cross-sectional view of the seat assembly along line A-A of FIG. 2 including the first embodiment of the energy absorbing apparatus when the seat back is in a forward position;

FIG. 12 is a cross-sectional view of the seat assembly along line A-A of FIG. 2 including the first embodiment of the energy absorbing apparatus when the seat back is in a rearward position;

FIG. 13 is a cross-sectional view of several seat assemblies including the first embodiment of the energy absorbing apparatus with the seat assemblies disposed in the shipping configuration and stacked upon each other;

FIG. 14 is a perspective view of a portion of the seat assembly including a second embodiment of an energy absorbing apparatus;

FIG. 15 is a cross-sectional view of the seat assembly along line C-C of FIG. 2 including the second embodiment of the energy absorbing apparatus when the seat back is in an upright position;

FIG. 16 is a cross-sectional view of the seat assembly along line C-C of FIG. 2 including the second embodiment of the energy absorbing apparatus when the seat back is in a forward position;

FIG. 17 is a cross-sectional view of the seat assembly along line C-C of FIG. 2 including the second embodiment of the energy absorbing apparatus when the seat back is in a rearward position;

FIG. 18 is a cross-sectional view of the seat assembly along line C-C of FIG. 2 including another configuration of the second embodiment of the energy absorbing apparatus when the seat back is in a forward position;

FIG. 19 is a cross-sectional view of the seat assembly along line C-C of FIG. 2 including another configuration of the second embodiment of the energy absorbing apparatus when the seat back is in a rearward position; and

FIG. 20 is a cross-sectional view of several seat assemblies including the second embodiment of the energy absorbing apparatus with the seat assemblies disposed in the shipping configuration and stacked upon each other.

### DETAILED DESCRIPTION OF THE INVENTION

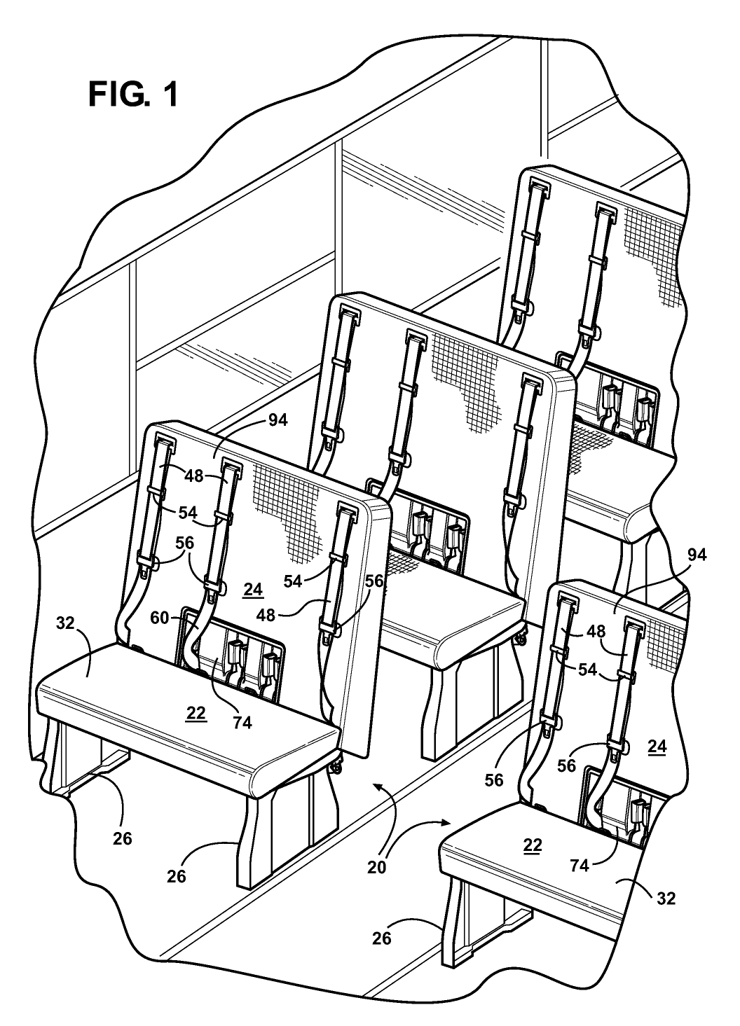

Referring to the Figures, wherein like numerals indicate corresponding parts throughout the several views, a seat assembly is generally shown at 20. As shown in FIG. 1, the seat assembly 20 is typically disposed in a vehicle such as, for example, a standard school bus. Accordingly, as is known in the art, several seat assemblies 20 can be incorporated into the school bus in rows. It should be appreciated that the seat assembly 20 may be used in any type of vehicle including, for example, an automobile, an airplane, or a boat.

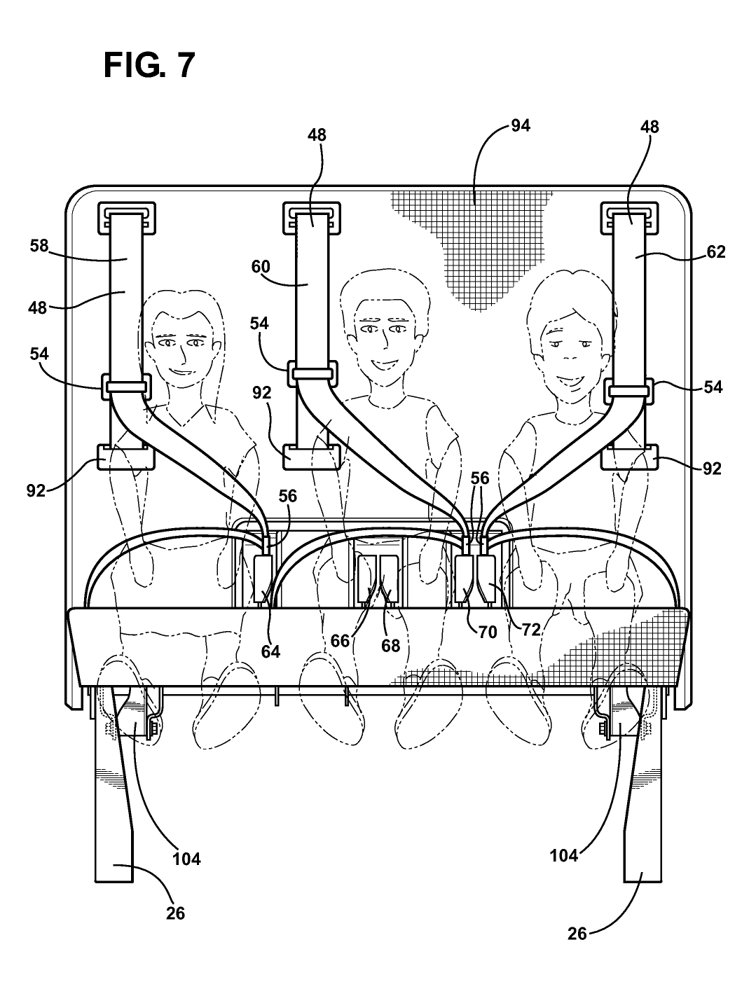

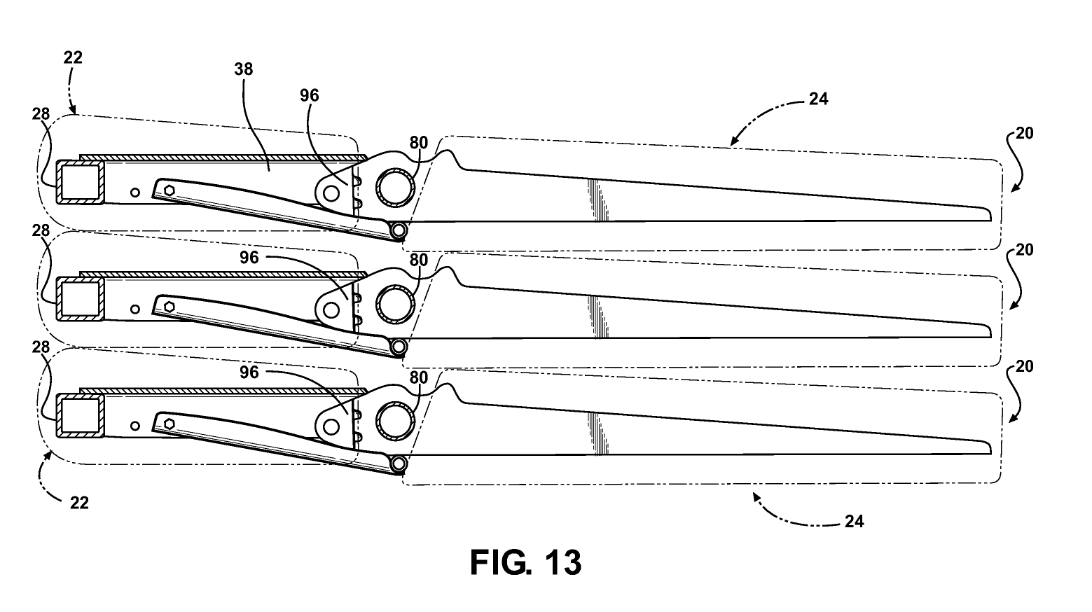

As set forth further below, the seat assembly 20 includes an energy absorbing apparatus 102, 202 for absorbing energy, such as, during front-end and rear-end collisions of the vehicle. A first embodiment of an energy absorbing apparatus 102 is shown in FIGS. 7-12 and a second embodiment of the energy absorbing apparatus 202 is shown in FIGS. 13-19. Common features among the first embodiment and second embodiment are labeled with common reference numerals in the Figures.

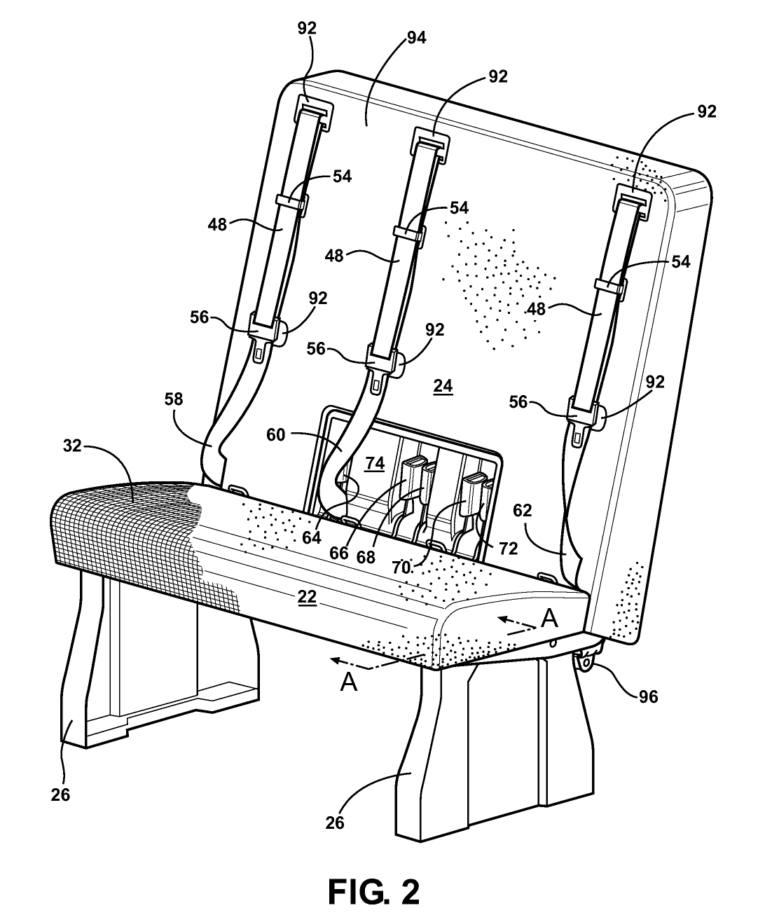

With reference to FIG. 2, the seat assembly 20 includes a seat bottom 22 extending generally horizontally and a seat back 24 extending generally vertically relative to the seat bottom 22. As described further below, the seat back 24 is pivotally coupled to the seat bottom 22. The seat assembly 20 typically includes mounting pedestals 26 attached to and extending downwardly from the seat bottom 22. The mounting pedestals 26 are typically mounted to a floor of the vehicle, as shown in FIG. 1. It should be appreciated that the seat assembly 20 may be coupled directly to a wall of the vehicle without departing from the nature of the present invention.

The seat bottom 22 typically includes a bottom frame 28 formed of metal. However, it should be appreciated that the bottom frame 28 can be constructed from other materials not described herein that are capable of providing the necessary support and strength.

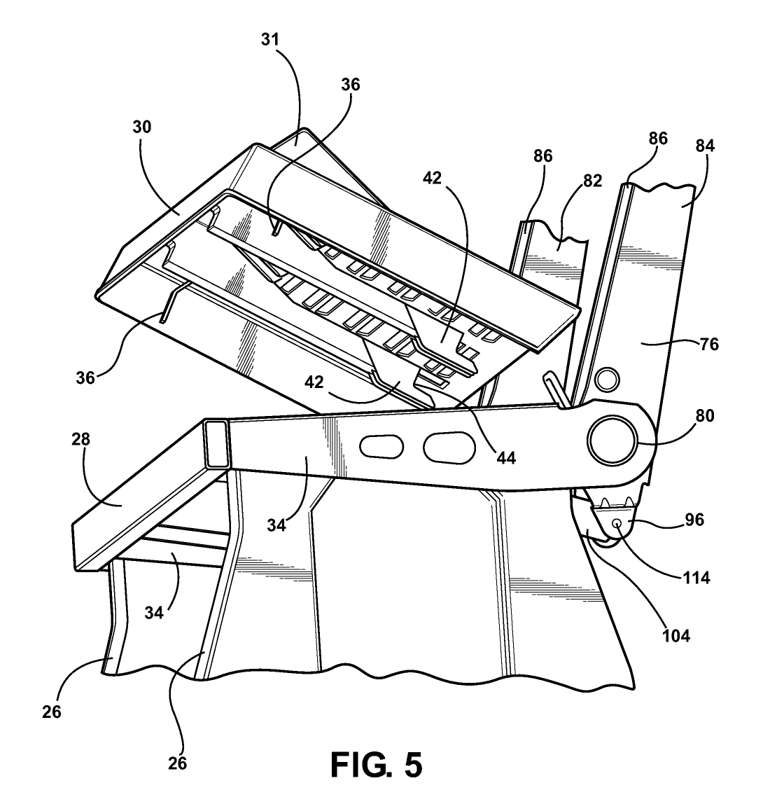

As best shown in FIG. 5, a seat pan 30 is typically disposed on the bottom frame 28. The seat pan 30 is, for example, formed by injection molding. However, it should be appreciated that the seat pan 30 can be formed from any material and by any method, such as, but not limited to blow molding or thermoforming without departing from the nature of the present invention. Alternatively, the seat pan 30 can be formed of plywood covered with foam and upholstery.

The seat pan 30 may include a ramp 31 along a front edge for urging occupants of the seat assembly 20 toward the seat back 24 and to reduce the likelihood that the occupant slides relative to the lap portion of a seatbelt when the vehicle is stopped abruptly resulting in improper occupant restraint as the lap portion of the seatbelt bears on softer abdominal tissue instead of the pelvic bone of the occupant, which is typically referred to in industry as “submarining.”

Seat upholstery 32 can be attached to the seat pan 30. For example, the seat upholstery 32 includes fabric and J-clips (not shown) attached to the fabric. In such a configuration, the J-clips attach to the seat pan 30 without the need for secondary fasteners. As such, the seat upholstery 32 is removable from the seat pan 30 by disconnecting the J-clips from the seat pan 30 such that the seat upholstery 32 can be easily removed for cleaning, repair, or replacement. Alternatively, the J-clips could attach to themselves, i.e., mating pairs, if the seat upholstery 32 is wrapped around the back panel 78, and the J-clips can connect directly to the seat pan 30 to fasten the seat upholstery 32 the seat cushion. As set forth above, the ramp 31 can be defined by the seat pan 30. Alternatively, the ramp 31 can be formed by disposing a separate element (not shown) between the seat pan 30 and the seat upholstery 32 without departing from the nature of the present invention.

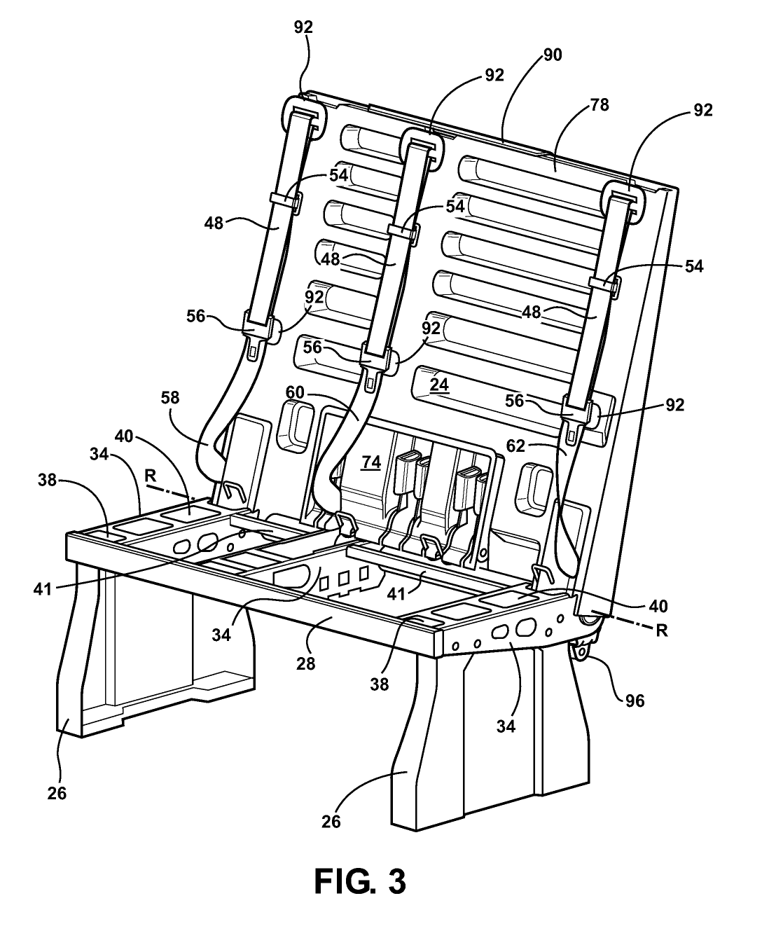

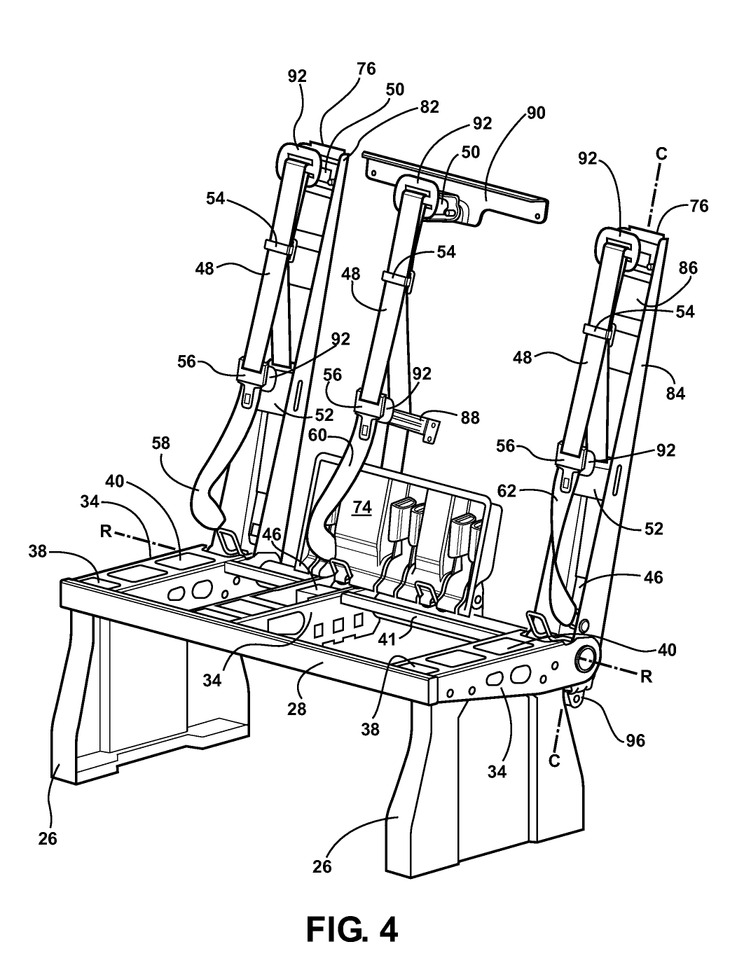

The bottom frame 28 of the seat bottom 22 has at least one support member 34 extending horizontally for supporting an occupant. As best shown in FIGS. 3 and 4, the bottom frame 28 typically includes three support members 34; however, it should be appreciated that the seat bottom can include any number of support members without departing from the nature of the present invention. The seat pan 30 is supported by the support member 34 for supporting the seated occupant.

With reference to FIG. 5, at least one clip 36 extends downwardly from the seat pan 30 to connect the seat pan 30 to the bottom frame 28. The clip 36 is moveable between an engaged position engaging the support member 34 for attaching the seat pan 30 to the support member 34 and a disengaged position disengaged from the support member 34 for selectively removing the seat pan 30 from the bottom frame 28.

Specifically, the support member 34 defines a hole 38 and the clip 36 extends into the hole 38 when the clip 36 is moved toward the engaged position. As such, a downward vertical force applied to the seat pan 30, such as the weight of the occupant on the seat pan 30, urges the clip 36 toward the engaged position. This configuration ensures attachment of the seat pan 30 to the support member 34 when the occupant is seated on the seat pan 30. Typically, the clip 36 is disposed on the seat pan 30 and the hole 38 is defined in the support member 34. Alternatively, the clip 36 can be on the support member 34 and the hole 38 can be defined in the seat pan 30 without departing from the nature of the present invention. The seat assembly 20 includes two clips 36 and two holes in the Figures; however, it should be appreciated that the seat assembly 20 can include any number of clips 36 and corresponding holes 38 without departing from the nature of the present invention.

The seat pan 30 includes a finger 42 engaging the bottom frame 28 to attach the seat pan 30 to the bottom frame 28. The seat pan 30 includes two fingers 42 in the Figures; however, it should be appreciated that the seat pan 30 can include any number of fingers 42 and corresponding without departing from the nature of the present invention.

The bottom frame 28 typically includes a cross bar 41 extending along a rear of the bottom frame 28. The fingers 42 slide under the cross bar 41 to engage the seat pan 30 to the bottom frame 28. It should be appreciated that the bottom frame 28 can include more than one cross bar 41 for engaging the fingers 42 without departing from the nature of the present invention.

In an alternative embodiment, the support member 34 defines a second hole 40 spaced from the hole 38 and the finger 42 extends from the seat pan 30 into the second hole 40. The finger 42 engages the support member 34 in the second hole 40 to attach the seat pan 30 to the support member 34. It should be appreciated that the seat assembly 20 can include any number of second holes 40 corresponding to the number of fingers 42 without departing from the nature of the present invention.

The seat pan 30 is connected to the bottom frame 28 by first engaging the fingers 42 with the bottom frame 28, e.g., inserting the fingers 42 into engagement with the cross bar 41. When inserted into the holes 38, the cross bar 41 is pinched between the fingers 42 and another portion of the seat pan 30. The seat pan 30 is then slid toward the seat back 24 to firmly seat the fingers 42 against the cross bar 41. The fingers 42 include a stop surface 44 that abuts the cross bar 41 to ensure proper location of the seat pan 30 relative to the support member 34, i.e., the seat pan 30 is properly located relative to the bottom frame 28 when the stop surface 44 abuts the cross bar 41.

When the seat pan 30 is properly located relative to the bottom frame 28, the clips 36 are aligned with the holes 38 in the support member 34. Once the seat pan 30 is properly located relative to the bottom frame 28, a downward force is exerted on the seat pan 30 to engage the clips 36 with the holes 38. Notably, the clip 36 is moveable to the engaged position only when the finger 42 is engaged with the hole 38.

To remove the seat pan 30 from the bottom frame 28, the clips 36 are biased away from the holes 38 in the support member 34 to allow the clips 36 to pass through the holes 38 such that the fingers 42 can be removed from the cross bar 41. The configuration allows for easy installation and removal of the seat pan 30 while ensuring a reliable connection between the seat pan 30 and the bottom frame 28. The seat pan 30 can be installed to and removed from the bottom frame 28 without the use of tools. Accordingly, the seat pan 30 can be easily removed for repair or replacement without complicated disassembly.

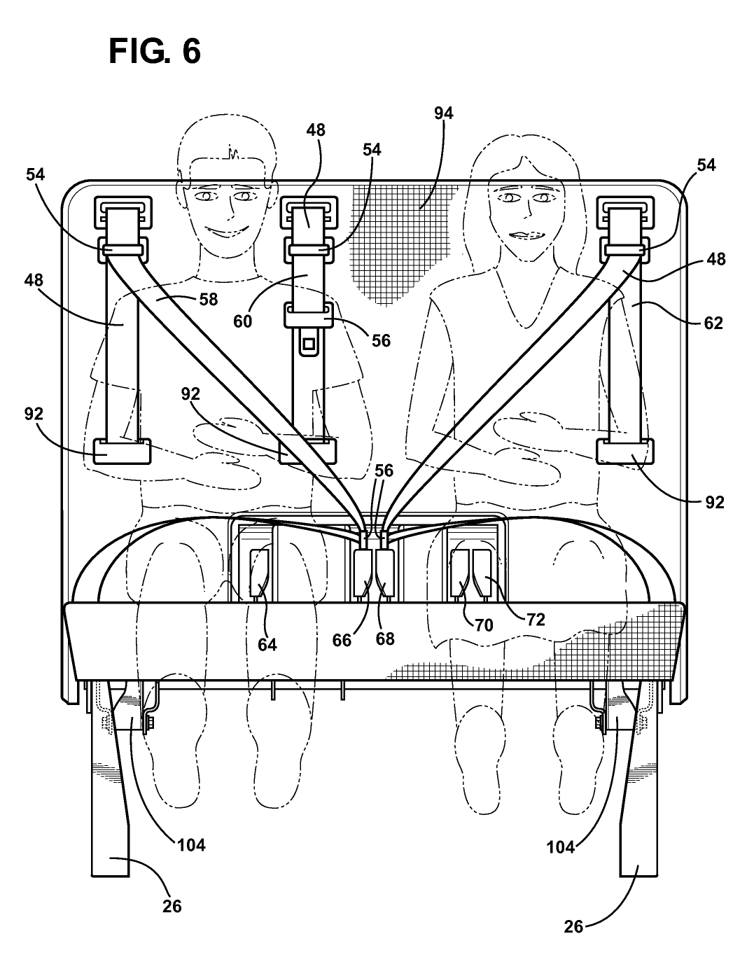

The seat assembly 20 includes a plurality of seatbelts and corresponding hardware configurable for use by either two larger occupants in a two occupant configuration, as shown in FIG. 6, or three smaller occupants in a three occupant configuration, as shown in FIG. 7. The seatbelts and the corresponding hardware can be that which are known in industry. Accordingly, the seatbelts and the seatbelt hardware are not described in detail herein. Additionally, methods of attaching the hardware to the support frame are also well known and are not described in detail herein. The hardware, for example, includes such items as a retractor 46, a belt 48, i.e., webbing, extendable from the retractor 46, a shoulder retainer 50, and a middle retainer 52 for receiving the belt 48 and to anchor the belt 48 to the seat back 24, a belt height adjuster 54, also referred to in industry as an webbing adjuster, coupled to the belt 48, and a latch plate 56 coupled to the belt 48. The belt height adjuster is moved up and down along the belt 48 depending on the shoulder height of the occupant seated in the seat assembly 20 in order to position the torso webbing across the clavicle of each properly seated occupant.

The seat assembly 20 includes a first seatbelt 58, a second seatbelt 60, and a third seatbelt 62. The first seatbelt 58 is coupled to the seat back 24. The second seatbelt 60 is coupled to the bottom frame 28 and the back panel 78, as shown in FIG. 4. The third seatbelt 62 is coupled to the seat back 24.

Referring to FIG. 2, moving along a rear edge, i.e., the bight line, of the seat back 24 along a direction from a left side to a right side of the seat back 24, the first seatbelt 58 is disposed at the left side. The second seatbelt 60 is disposed at approximately ⅓ of the distance from the left side to the right side. The third seatbelt 62 is disposed at the right side.

The seat assembly 20 includes a plurality of buckles for receiving the latch plates 56 of the first 58, second 60, and third 62 seatbelts, respectively. Specifically, the seat assembly includes a first buckle 64, a second buckle 66, a third buckle 68, a fourth buckle 70, and a fifth buckle 72. With reference to FIG. 2, moving along the rear edge of the seat back 24 along the distance from the left side to the right side of the seat back 24, the first buckle 64 is disposed at approximately ⅓ of the distance from the left side to the right side. The second 66 and third 68 buckles are disposed at approximately ½ of the distance from the left side to the right side. The fourth 70 and fifth 72 buckles are disposed at approximately ⅔ of the distance from the left side to the right side. As best shown in FIG. 4, a tray 74 is typically disposed in the seat back 24 to house the buckles.

Typically, the second 66 and third 68 buckles and the fourth 70 and fifth 72 buckles are disposed adjacent each other, i.e., can be moved independently of each other. Alternatively, the second 66 and third 68 buckles can integrally extend from each other and the fourth 70 and the fifth 72 buckles can integrally extend from each other.

When the seat assembly 20 is utilized for seating the two larger occupants, as shown in FIG. 6, the latch plate 56 of the first seatbelt 58 locks into the second buckle 66 and the latch plate 56 of the third seatbelt 62 locks into the third buckle 68. Alternatively, when the seat assembly 20 is utilized for seating the three smaller occupants, as shown in FIG. 7, the latch plate 56 of the first seatbelt 58 locks into the first buckle 64, the latch plate 56 of the second seatbelt 60 locks into the fourth buckle 70, and the latch plate 56 of the third seatbelt 62 locks into the fifth buckle 72.

Accordingly, the first 64, fourth 70, and fifth 72 buckles are not utilized in the two occupant configuration. Likewise, the second 66 and third 68 buckles are not utilized in the three occupant configuration. Therefore, if one does not want the versatility of switching between the two occupant configuration and the three occupant configuration, and only wishes to provide seating for the two occupant configuration, then the first 64, fourth 70, and fifth 72 buckles, may be omitted from the seat assembly 20 to reduce cost Likewise, if one only wishes to provide seating for the three occupant configuration, then the second 66 and third 68 buckles may be omitted from the seat assembly 20 to reduce cost.

The latch plates 56 on the seatbelts and the buckles are typically visually coded and/or keyed to assist the occupants in properly pairing the latch plates 56 and the buckles for the two occupant configuration or the three occupant configuration. Specifically, with respect to visual coding, the latch plate 56 on the second seatbelt 60 is visually coded similarly to the fourth buckle 70 to indicate to occupants that the latch plate 56 on the second seatbelt 60 corresponds to the fourth buckle 70. For example, the visual coding includes color coding such that corresponding latch plates 56 and buckles are similarly colored. Another example of visual coding includes text printed on or imbedded on the latch plates 56 and buckles. Likewise, with respect to keying, the latch plate 56 on the second seatbelt 60 is keyed similarly to the fourth buckle 70 so that the latch plate 56 on the second seatbelt 60 can only engage the fourth buckle 70.

With reference to FIGS. 2-4, the seat back 24 includes a back frame 76 and a back panel 78 disposed over the back frame 76. The back panel 78 will be discussed in further detail below. The back frame 76 is typically formed of a metal, such as steel or aluminum. However, it should be understood that the back frame 76 may be constructed from other materials not described herein that are capable of providing the necessary support and strength. The seat back 24 may include foam pillows or other cushioning material (not shown) positioned to absorb energy from an occupant who uncontrollably strikes the seat back 24 in front of the occupant when the vehicle is accelerated abruptly.

As shown in FIG. 4, the seat assembly 20 includes a rod 80. The support member 34 of the seat bottom 22 extends transversely to the rod 80. The support member 24 typically defines a hole receiving the rod 80 for coupling the support member 24 and the rod 80.

The back frame 76 includes a first tower 82 and a second tower 84, each extending generally upwardly from the rod 80. Typically, the rod 80 is cylindrical, i.e., has a round cross-section, and both of the first 82 and the second 84 towers defines a round hole receiving the rod 80. The rod 80 and the round holes are sized such that the towers 82, 84 are rotatable about the rod 80. Specifically, the rod 80 extends along a rotational axis R and the towers 82, 84 selectively rotate about the rotational axis R, as set forth further below.

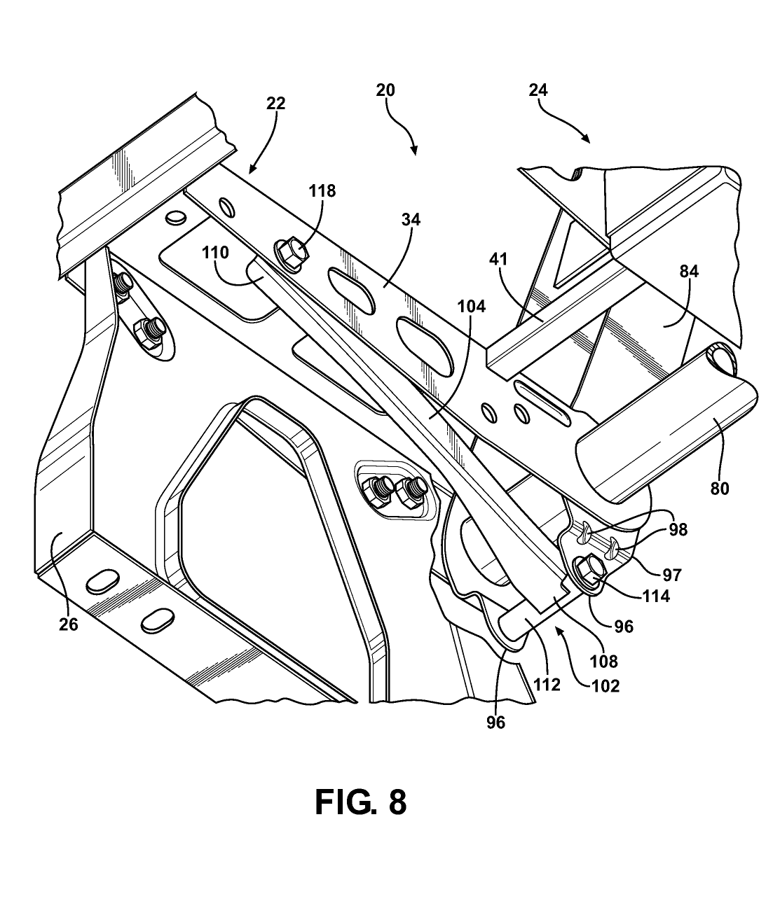

At least one extension 96 extends from seat back 24 and more specifically from the towers 82, 84. The first 82 and second 84 towers are spaced about the rotational axis R from the extension 96 for supporting an occupant seated on the seat bottom 22. Each tower 82, 84 typically includes a pair of extensions 96, as best shown in FIG. 8; however, it should be appreciated that the towers 82, 84 can include one, two, or more extensions 96 without departing from the nature of the present invention. The towers 82, 84 and the extension 96 typically extend along a common axis C that intersects the rotational axis R. However, it should be appreciated that the extension 96 can extend transversely to the towers 82, 84 without departing from the nature of the present invention.

The back panel 78 structurally reinforces the towers 82, 84 of the seat back 24. In other words, the back panel 78 ties together the towers 82, 84 and creates a structure for the seat back 24. The back panel 78 is typically formed by blow molding. However, it should be appreciated that the back panel 78 can be formed from any material and by any method, such as, but not limited to plastic injection molding, thermoforming, metal stamping welded to the back frame 76, etc. without departing from the nature of the present invention.

The back panel 78 is typically hollow and receives each of the towers 82, 84. Typically the back panel 78 has a back portion presenting a concave configuration for increasing a space between the back panel 78 and a subsequent row. It should be appreciated that there are requirements for spacing between rows of seat assemblies 20 on school buses. It is advantageous to provide a seat assembly 20 with a concave seat back 24 such that the concave seat back 24 provides additional spacing which allows for the installation of the maximum number of rows of seat assemblies 20 in a school bus by efficiently designing the seat back 24 to be of the minimum thickness necessary to meet the performance requirement.

With reference to FIG. 4, both of the towers 82, 84 define a channel 86, i.e., both of the towers 82, 84 are generally U-shaped. The retractors 46 of the first 58 and third 62 seatbelts are disposed in the channel 86 of the first 82 and the second 84 towers, respectively, and are connected to the first 82 and second 84 towers, respectively. As such, the belt extends upwardly from the retractor 46 within the channel 86 to the shoulder retainer 50 along the outside of the back panel 78. Typically, the middle retainer 52 is coupled along the tower 82, 84 and the shoulder retainer 50 is coupled near an end of the tower 82, 84 opposite the support member 34. It is to be appreciated that the positioning of the middle retainer 52 and the shoulder retainer 50 may vary without departing from the nature of the present invention.

The retractor 46 of the second seatbelt 60 is connected to the middle support member 34. A web guide 88 for the second seatbelt 60 is coupled to the back panel 78 for allowing the second seatbelt 60 to pass through the back panel 78. A reinforcing bracket 90 is attached to a back side of the back panel 78 for supporting the shoulder retainer 50 for the second seatbelt 60. The shoulder retainer 50 and the web guide 88 for the second seatbelt 60 are each configured to guide the belt 48 inside the channels 86 within the back panel 78 so that the belt 48 can pass through back panel 78 at bezels 92 adjacent the middle retainer 52.

The rod 80 can define a depression (not shown) for allowing the second seatbelt 60 to wrap around the rod 80 and into the back panel 78. The second seatbelt 60 then continues to the shoulder retainer 50, in a similar fashion as the first 58 and third 62 seatbelts, and then out through the bezel 92.

The configuration of the seatbelts strung between the middle retainer 52 and the shoulder retainer 50 advantageously reduces or eliminates lateral forces, i.e., twisting of the seat back 24, when the seatbelt is activated to retain an occupant. In other words, the belt 48 of the seatbelt exerts primarily a bending force on the tower 82, 84. As such, material that increases the resistance of the towers 82, 84 to twisting can be reduced, which is advantageous with respect to cost to manufacture and packaging.

Back upholstery 94 can be attached to the back panel 78. For example, the back upholstery 94 can include fabric and J-clips (not shown) attached to the fabric. As with the seat upholstery 32 on the seat bottom 22, the J-clips attach to the back panel 78 of the seat back 24 or to each other, i.e., interlocking J-clips. As such, the back upholstery 94 is removable from the seat back 24 by disconnecting the J-clips from the back panel 78.

The buckles are spring loaded such that the buckles are biased toward the tray 74. As such, the occupant pulls the buckle out of the tray 74 against the bias of the spring load to lock one of the latch plates 56 into the buckle. When the latch plate 56 is released from the buckle, the spring load biases the buckle toward the tray 74 and the buckle recesses back into the tray 74. As such, the occupants comfortably sit on the seat assembly 20 without uncomfortable contact with any one of the buckles. Specifically, in the two occupant configuration, one of the occupants is seated in front of the first buckle 64 and the other occupant sits in front of the fourth 70 and fifth 72 buckles. In the three occupant configuration, a middle occupant is seated in front of the second 66 and third 68 buckles.

The energy absorbing apparatus 102, 202 controls pivoting of the seat back 24 relative to the seat bottom 22. When no loads are applied to the seat back 24, the energy absorbing apparatus 102, 202 maintains the seat back 24 in an upright position, as shown in FIG. 13, to support the back of occupants seated on the seat assembly 20. Said differently, the energy absorbing apparatus 102, 202 couples the towers 82, 84 of the seat back 24 to the seat bottom 22 for providing rigidity to the seat back 24 in the upright position. It should be appreciated that the “upright position” can also be referred to as the design position because it is a position of the seat back 24 as designed to support the back of occupants during normal use. As such, it should be appreciated that the “upright position” can be vertical or can be angled forwardly or rearwardly from vertical.

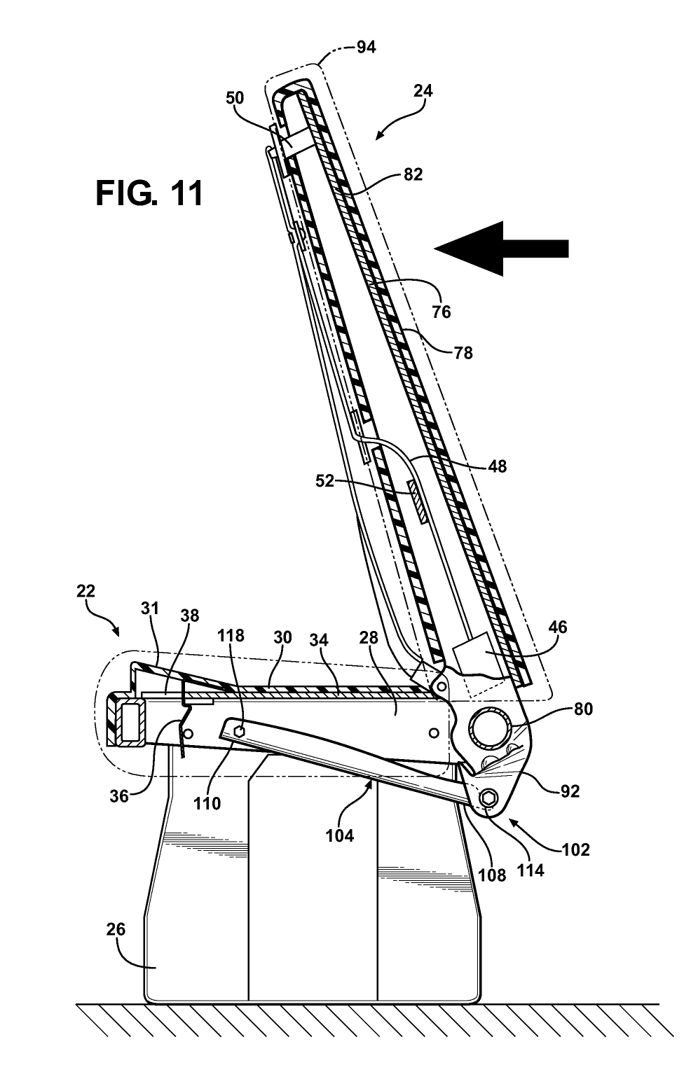

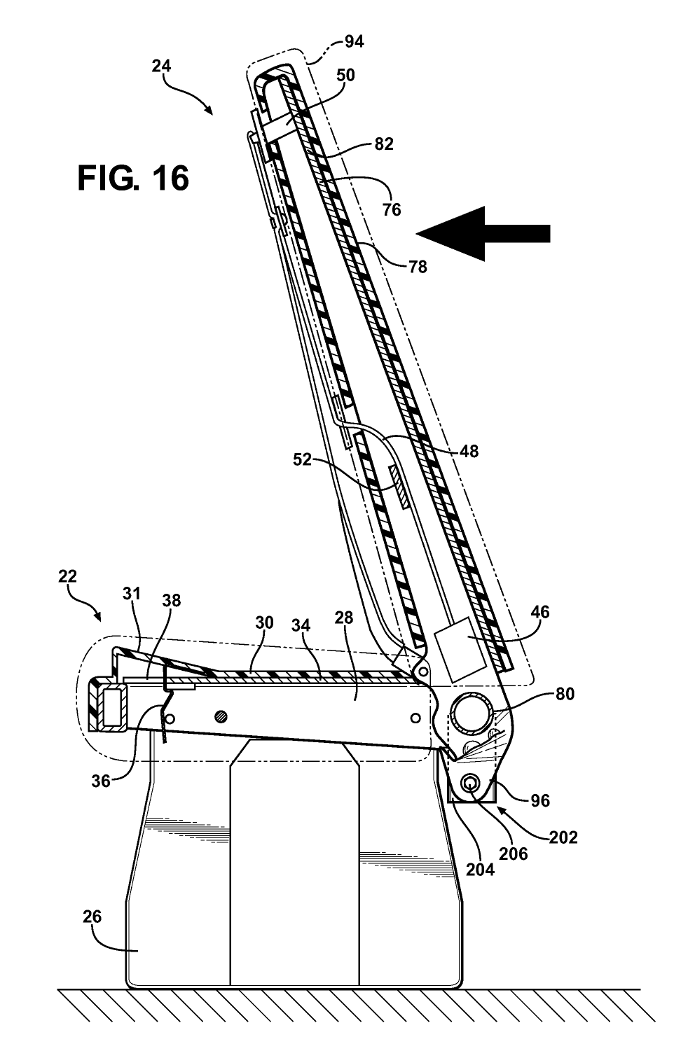

As described further below, the energy absorbing apparatus 102, 202 allows the seat back 24 to rotate relative to the seat bottom 22 when sufficient force is applied to the seat back 24. The seat back 24 can rotate from the upright position in forward rotation to a forward position, for example, to absorb energy from an occupant who uncontrollably moves forward and strikes the seat back 24 in front of the occupant when the vehicle is abruptly stopped. The seat back 24 rotates toward the seat bottom 22 from the upright position to the forward position, as shown in FIGS. 11 and 16.

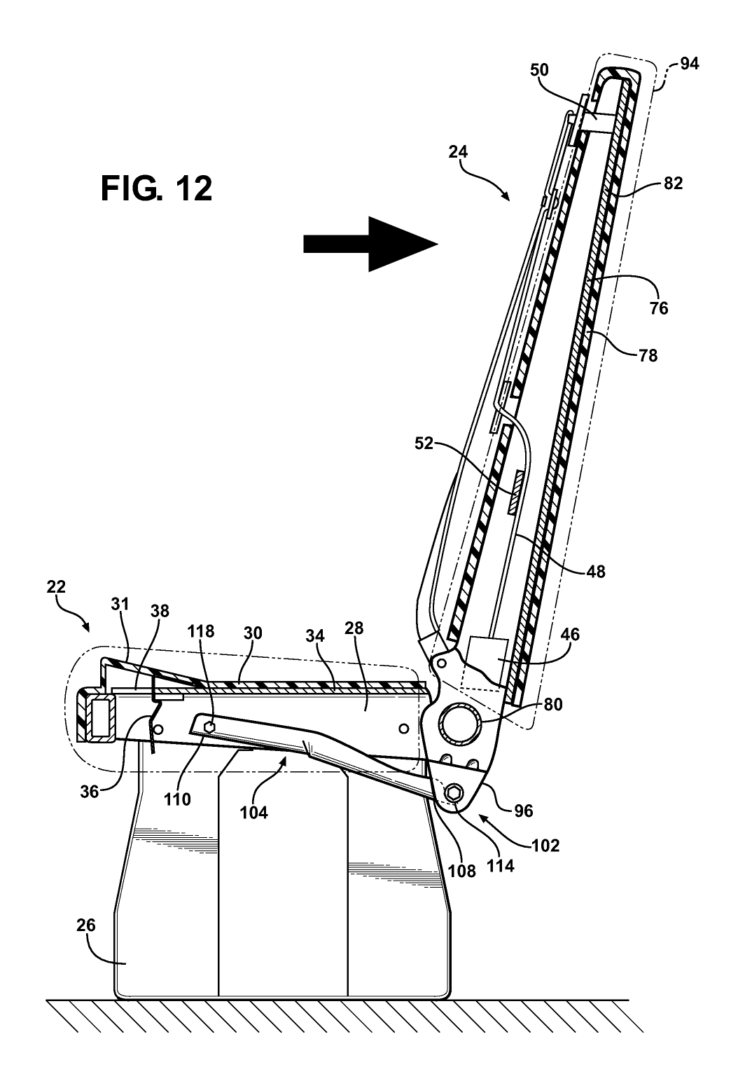

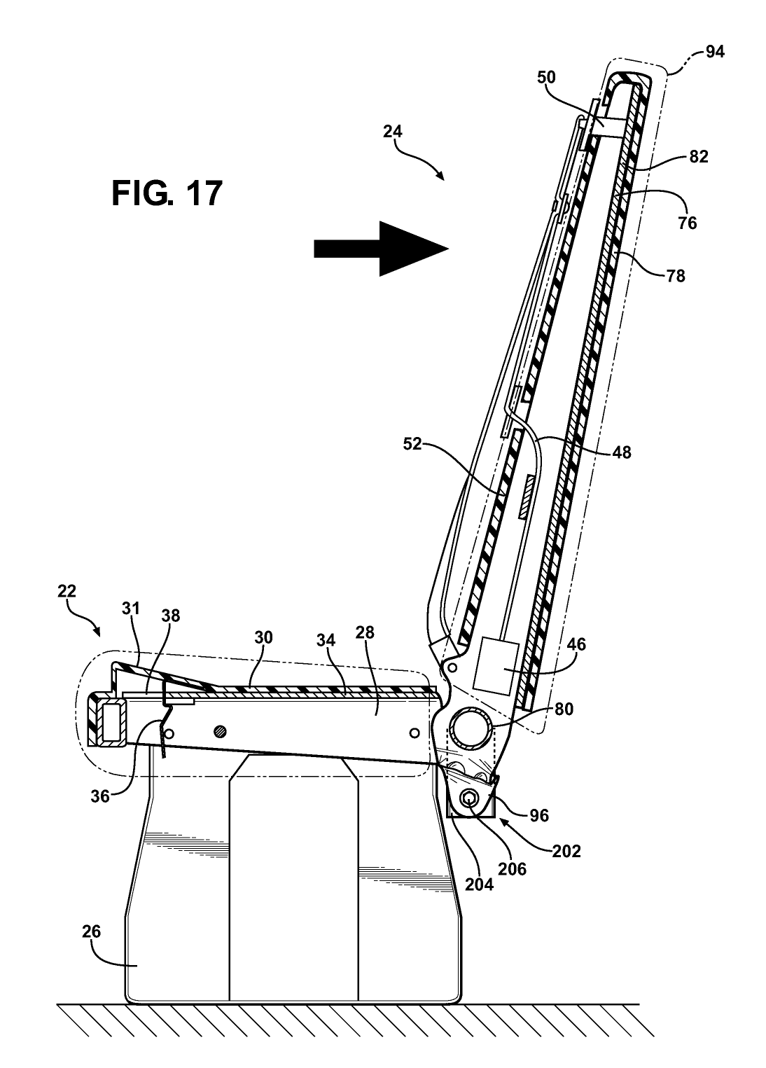

In addition, the seat back 24 can rotate from the upright position in rearward rotation to a rearward position, for example, to absorb energy from an occupant who moves into the seat assembly 20 in which the occupant is seated during a rear-end collision or during rebound after a frontal collision. The seat back 24 rotates away from the seat bottom 22 from the upright position to the rearward position, as shown in FIGS. 12 and 17.

In the present invention, the seat back 24 of the seat assembly 20 on which the occupant is seated must provide adequate support such that the seatbelt locks and prevents the occupant from flying forward. In other words, the seat back 24 must remain in a generally upright position in order for the seatbelt to properly function and stop the occupant buckled thereto from uncontrollably moving forward. However, some occupants may forget or refuse to use the seatbelt and in a situation involving an abrupt stop, the occupant who is not buckled to with the seatbelt can move forward and strike the seat back 24 of the seat assembly 20 in front of the occupant. Therefore, the seat back 24 of the present invention has some energy absorbing capability in order to absorb energy from the unseated occupant, as required by the National Highway Transportation Safety Administration's (NHTSA) Federal Motor Vehicle Safety Standards (FMVSS), specifically FMVSS 222.

As such, the energy absorbing apparatus 102, 202 is designed to provide such energy absorbing capability while also maintaining the seat back 24 in the generally upright position during normal use, i.e., the energy absorbing apparatus 102, 202 allows for some rotation of the seat back 24 but also limits the rotation of the seat back 24 to a predetermined rotational angle.

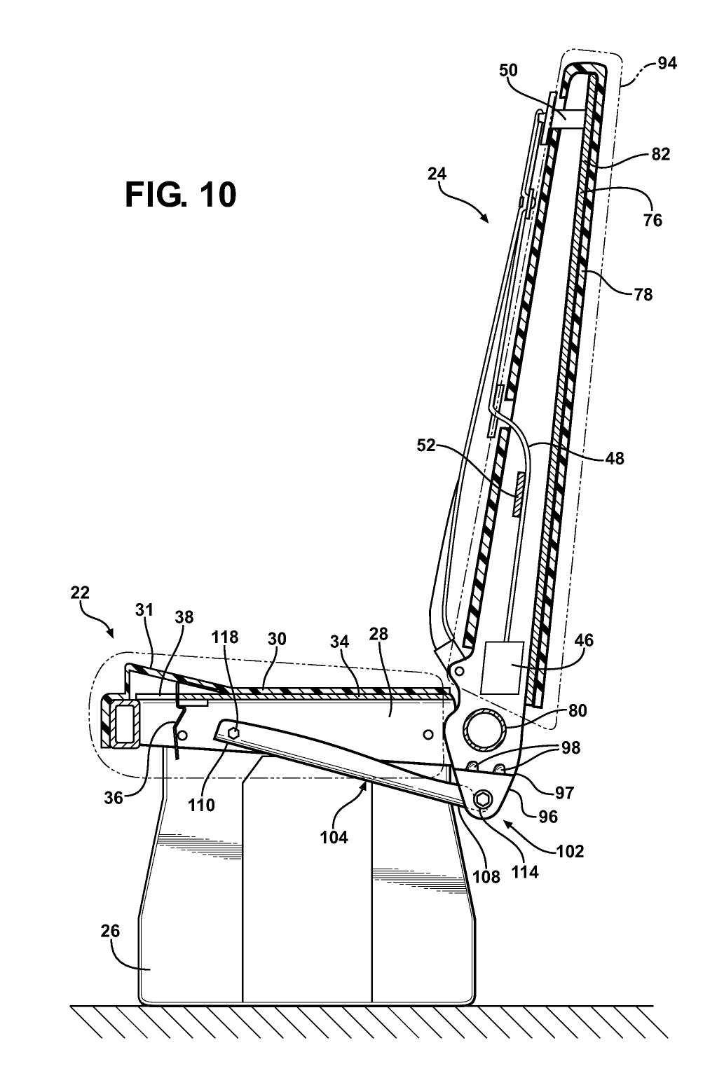

The first embodiment of the energy absorbing apparatus 102 is described below with reference to FIGS. 8-13. As shown in FIG. 8, the energy absorbing apparatus 102 includes the extension 96 and a member 104 coupled to the extension 96 and to the seat bottom 22 for selectively maintaining the seat back 24 in the upright position. In other words, under normal conditions, such as during the absence of excessive force on the seat back 24, the member 104 maintains the seat back 24 in the upright position shown in FIG. 10 to support the backs of occupants seated in the seat assembly 20. As set forth further below, the member 104 remains relatively undeformed and the extension 96 deforms, e.g., bends, to absorb energy when the seat back 24 rotates in forward rotation toward the seat bottom 22, as shown in FIG. 11. As shown in FIG. 12, the extension 96 remains relatively undeformed and the member 104 deforms, e.g., buckles, to absorb energy when the seat back 24 rotates in rearward rotation away from the seat bottom 22. In addition, the member 104, the extension 96, and the support member 34 prevent excessive movement of the seat back 24 in forward rotation and rearward rotation.

Typically, the seat assembly 20 includes two members 104 with one of the members 104 coupled to the first tower 82 and with the other of the members 104 coupled to the second tower 84. However, it should be appreciated that the seat assembly 20 can include any number of members 104 without departing from the nature of the present invention.

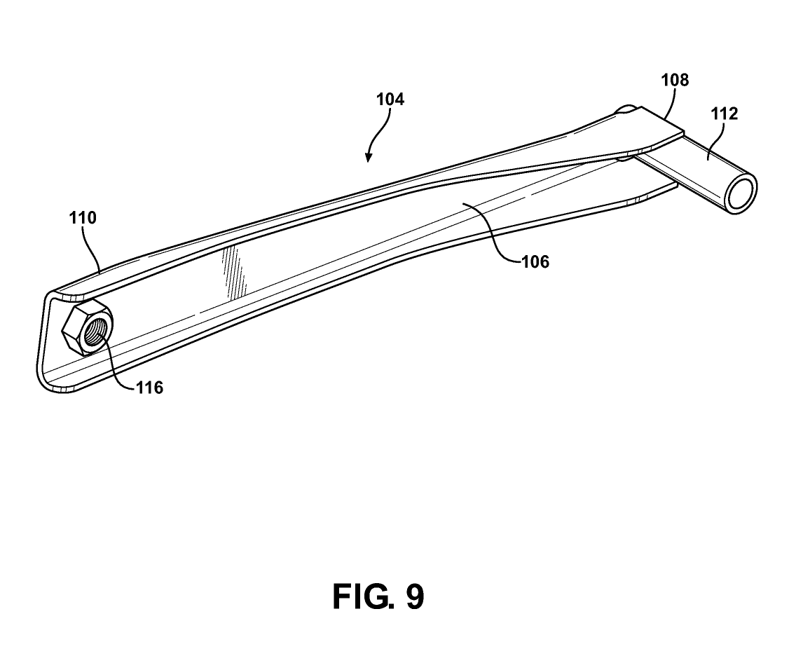

With reference to FIG. 9, the member 104 typically defines a channel 106. The depth of the channel 106 along the length of the member 104 can be tuned to change the magnitude of force necessary to deform the member 104 and to change the location of the point of deformation along the member 104. The member 104 is typically formed of metal; however, it should be appreciated that the member 104 can be formed in any shape and of any material without departing from the nature of the present invention.

The member 104 includes a first end 108 for connection to the extension 96 and a second end 110 for connection to the support member 34 of the seat bottom 22. The first end 108 can include a bushing 112 for receipt of a fastener 114, such as a bolt, that connects the member 104 to the extension 96. The second end 110 typically includes a hole 116 for receipt of another fastener 118, such as a bolt, that connects the member 104 to the support member 34 of the seat bottom 22. However, it should be appreciated that the member 104 can be coupled to the extension 96 and the support member 34 of the seat bottom 22 in any fashion without departing from the nature of the present invention. It should also be appreciated that the member 104 can be directly connected to the extension 96 and the seat bottom 22 or can be indirectly coupled to the extension 96 and the support member 34 of the seat bottom 22, i.e., with the use of intermediate components.

The seat back 24 is capable of folding flat for shipping prior to introduction into the vehicle. In such a shipping configuration, the member 104 is attached to the bottom frame 28 and unattached to the tower 82, 84; attached to the tower 82, 84 and unattached to the bottom frame 28; or unattached to both the bottom frame 28 and the tower 82, 84. As such, a plurality of seat assemblies can be stacked, as shown in FIG. 13. When the seat assembly 20 is installed into the vehicle, the seat back 24 is moved to the upright position and the member 104 is positioned to be attached to both the bottom frame 28 and the respective tower 82, 84.

The extension 96 is deformable relative to the member 104 when the seat back 24 rotates in forward rotation and is rigid relative to the member 104 when the seat back 24 rotates in rearward rotation. In other words, the extension 96 deforms and the member 104 remains relatively rigid and undeformed when the seat back 24 rotates in forward rotation. The member 104 deforms and the extension 96 remains relatively rigid and undeformed when the seat back 24 rotates in rearward rotation.

Specifically, the seat back 24 can move in forward rotation when an occupant seated behind the seat back 24 moves forward and strikes the seat back 24, such as during a front-end collision. If the occupant uncontrollably moves forward and impacts the seat back 24 of the seat assembly 20 in front of the occupant, e.g., during a front-end collision, the seat back 24 in front of the occupant rotates in forward rotation to absorb energy from the occupant, as required by FMVSS 222. In such a situation, the extension 96 deforms, as described further below, thereby allowing the seat back 24 to rotate relative to the seat bottom 22 and to absorb the occupant's energy.

The seat back 24 can move in rearward rotation when the occupant seated in the seat back 24 moves back into the seat back 24, such as during a rear-end collision or during rebound from a front-end collision. Specifically, if the occupant moves backward and impacts the seat back 24 of the seat assembly 20 the occupant is sitting in, e.g., during a rear-end collision or during rebound from a front-end collision, the seat back 24 rotates in rearward rotation to absorb energy from the occupant, as required by FMVSS 222. In such a situation, the member 104 deforms, as described further below, thereby allowing the seat back 24 to rotate relative to the seat bottom 22 and to absorb the occupant's energy.

The extension 96 is deformable relative to the member 104 when the seat back 24 rotates in forward rotation and is rigid relative to the member 104 when the seat back 24 rotates in rearward rotation because the member 104 has different failure modes in tension and in compression. Forward rotation tensions the member 104 between the seat bottom 22 and the seat back 24 and rearward rotation compresses the member 104 between the seat bottom 22 and the seat back 24.

The force required to deform the member 104 in tension, i.e., the tensile force, is greater than the compressive force required to deform the member 104, i.e., the buckling force. Further, the extension 96 and the member 104 are designed such that the extension 96 deforms when subjected to a force less than the tensile force of the member 104 and greater than the buckling force of the member 104. As such, when the seat back 24 rotates in forward rotation, the extension 96 is deformable relative to the member 104 and deforms before the magnitude of the tension on the member 104 reaches the tensile force. When the seat back 24 rotates in rearward rotation, the member 104 buckles before the force on the extension 96 reaches a magnitude sufficient to deform the extension 96.

Because energy is absorbed by different components depending upon the direction of rotation, i.e., the extension 96 deforming in forward rotation and the member 104 buckling in rearward rotation, absorption of energy in forward rotation and rearward rotation is decoupled. In other words, the load absorption characteristics of the extension 96 and the member 104 can be designed and tuned independently of each other to optimize load absorption during forward and rearward rotation of the seat back 24 as long as the extension 96 deforms when subjected to a force less than the tensile force of the member 104 and greater than the compressive force of the member 104.

Typically, the member 104 and the extension 96 can be designed such that the seat assembly 20 meets the standards set forth in the Federal Motor Vehicle Safety Standards. The load absorption of the member 104 can be designed and optimized by altering geometry and material type of the member 104. For example, as set forth above, the depth of the channel 106 along the length of the member 104 can be tuned to change the load absorption of the member 104. In addition, the thickness of the member 104 can be tuned to change the load absorption of the member 104.

The extension 96 can also be designed and optimized by altering the geometry and the material type of the extension 96. For example, the thickness of the extension 96 can be tuned to change the load absorption of the extension 96.

With reference to FIG. 8, the extension 96 can define a bend 97 extending along the extension 96 for altering the rigidity of the extension 96. The bend 97 is typically defined between the fastener 114 and the rod 80.

In the alternative to or in addition to the bend 97, the extension 96 can define one or more dimples 98 to alter the rigidity of the extension 96. For example, the dimples 98 can be defined along the bend 97, as shown in FIG. 8. It should be appreciated that the extension 96 can include other contours and features in addition to or in the alternative to the bend 97 and the dimples 98 to alter the rigidity of the extension 96. Typically, both of the extensions 96 deform as set forth above; however, it should be appreciated that only one of the extensions 96 can deform while the other remains undeformed.

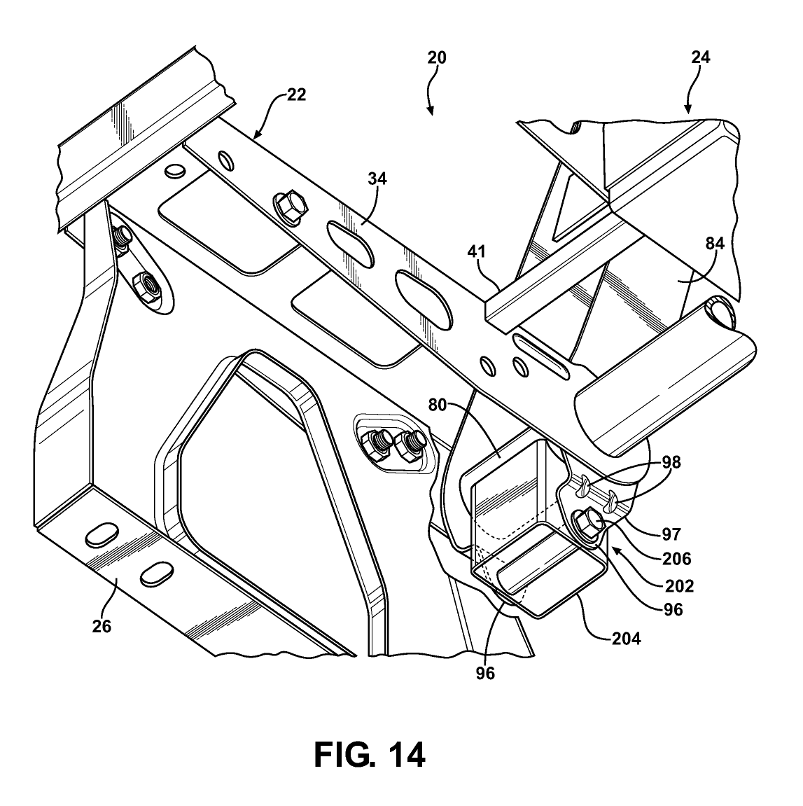

The second embodiment of the energy absorbing apparatus 202 is described below with reference to FIGS. 14-19. The second embodiment of the energy absorbing apparatus 202 includes the extension 96 and the member 204. In the second embodiment, the seat back 24, i.e., the first 82 and second 84 towers, is rotatably coupled to the rod 80 as set forth above. The member 204 is fixed to the rod 80, i.e., does not move relative to the rod 80, and extends from the rod 80 to the extension 96. For example, the member 204 is welded to the rod 80; however, it should be appreciated that the member 204 can be fixed to the rod 80 in any fashion such that the member 204 rigidly extends from the rod 80 without departing from the nature of the present invention. The rod 80 is fixed relative to the bottom frame 28 of the seat bottom 22, i.e., the rod 80 does not move relative to the bottom frame 28.

The member 204 is fixed to the extension 96. Typically, the member 204 is pinned to the extension 96 with the use of a fastener 206, such a bolt, that extends through holes in the member 204 and the extension 96. However, it should be appreciated that the member 204 can be fixed to the extension 96 in any fashion without departing from the nature of the present invention.

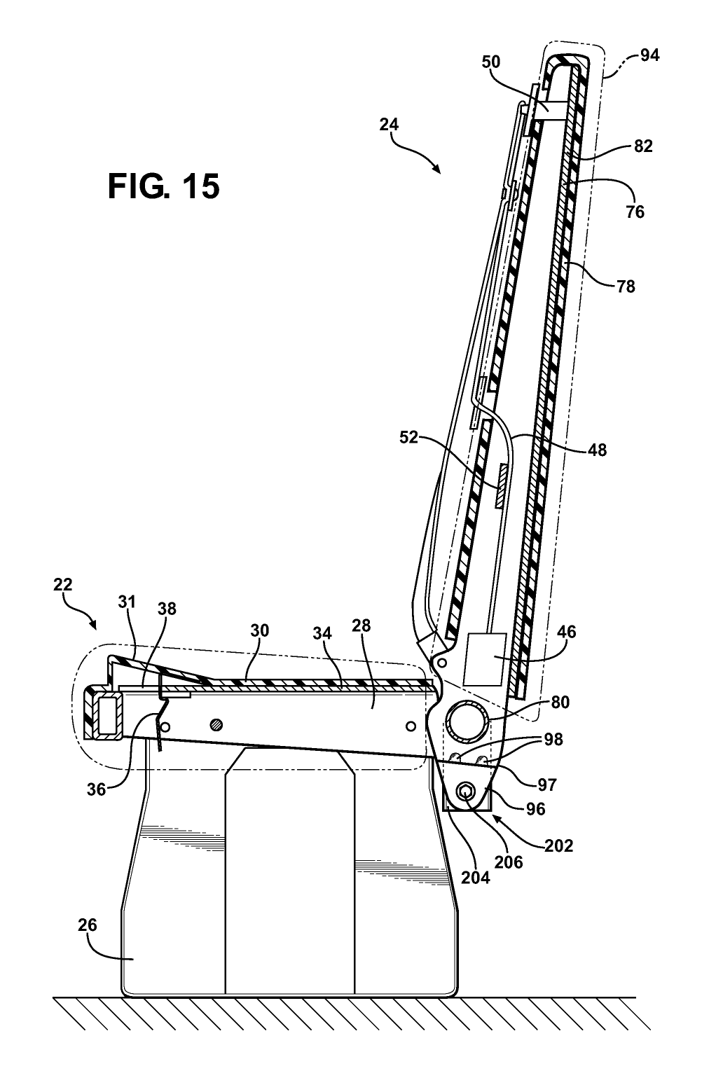

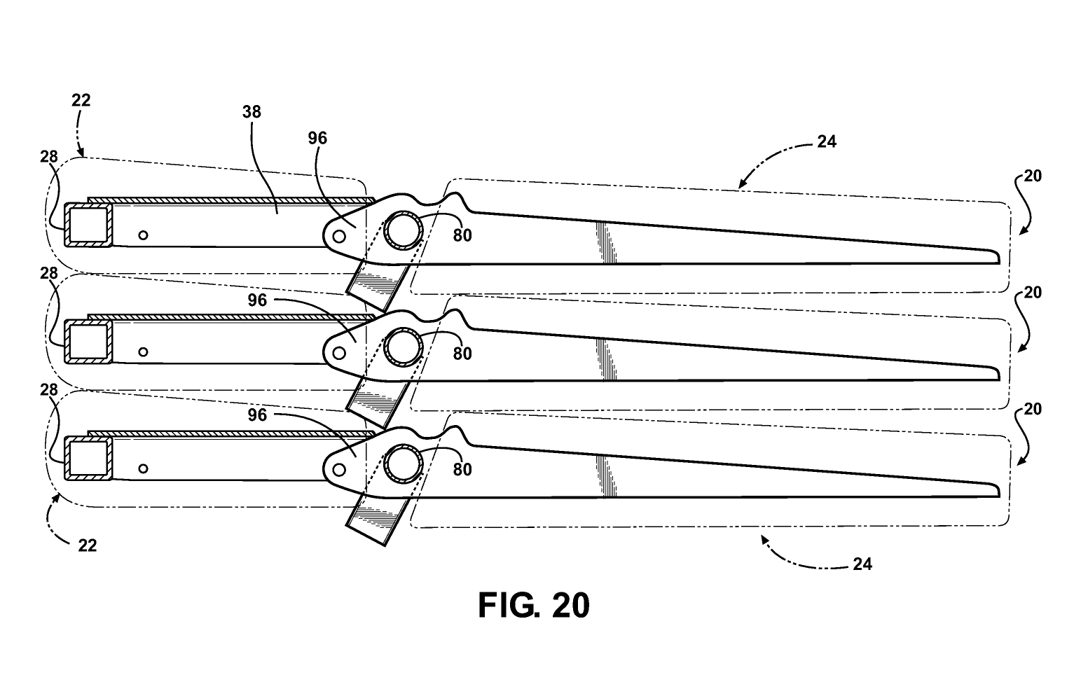

The seat back 24 is capable of folding flat for shipping prior to introduction into the vehicle. In such a shipping configuration, member 204 is unattached to the extension 96 such that the seat back 24 can be disposed in a flat position. As such, a plurality of seat assemblies can be stacked, as shown in FIG. 20. As set forth above, the member 204 is fixed to the rod 80 and the rod 80 is fixed to the seat bottom 22. As such, the seat bottom 22, the rod 80, and the member 204 do not move relative to each other. When the seat assembly 20 is installed into the vehicle, the seat back 24 is rotated relative to the seat bottom 22, the rod 80, and the member 204 to the upright position such that the member 204 and extension 96 are positioned to be attached with the fastener 206. It should be appreciated that the member 204 is fixed to the rod 80 and can extend at a generally perpendicular angle relative to the seat bottom 22 as shown, for example, in FIGS. 14 and 15. Alternatively, as shown in FIG. 20, the member 204 is fixed to the rod 80 and extends at a non-perpendicular angle relative to the seat bottom 22. It should be appreciated that the member 204 can extend at any angle relative to the seat bottom 22 without departing from the nature of the present invention.

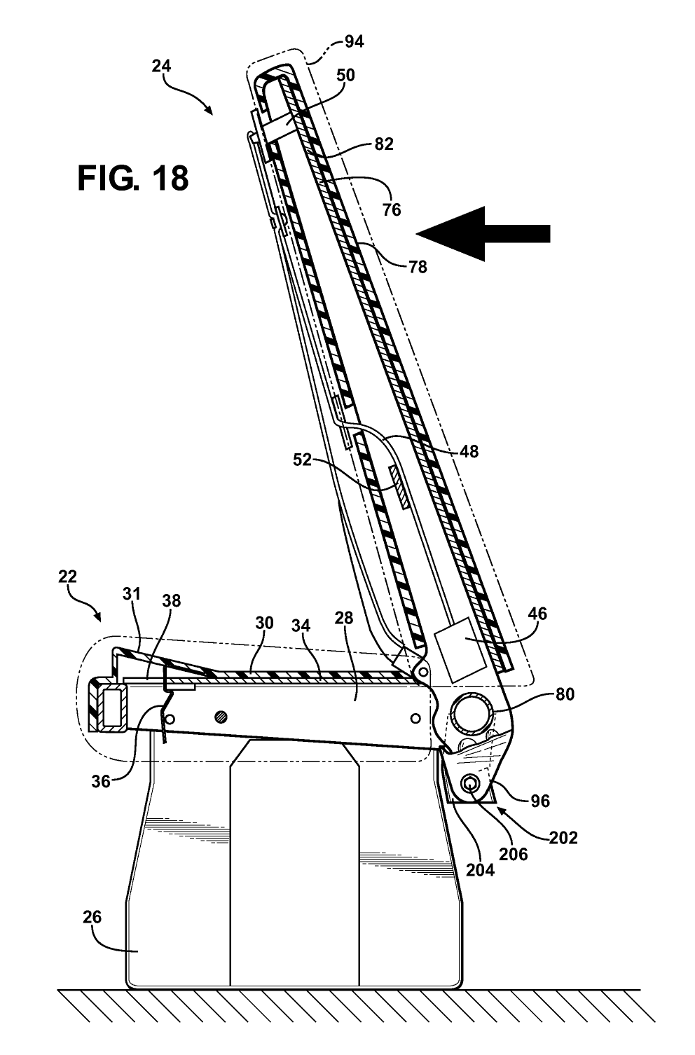

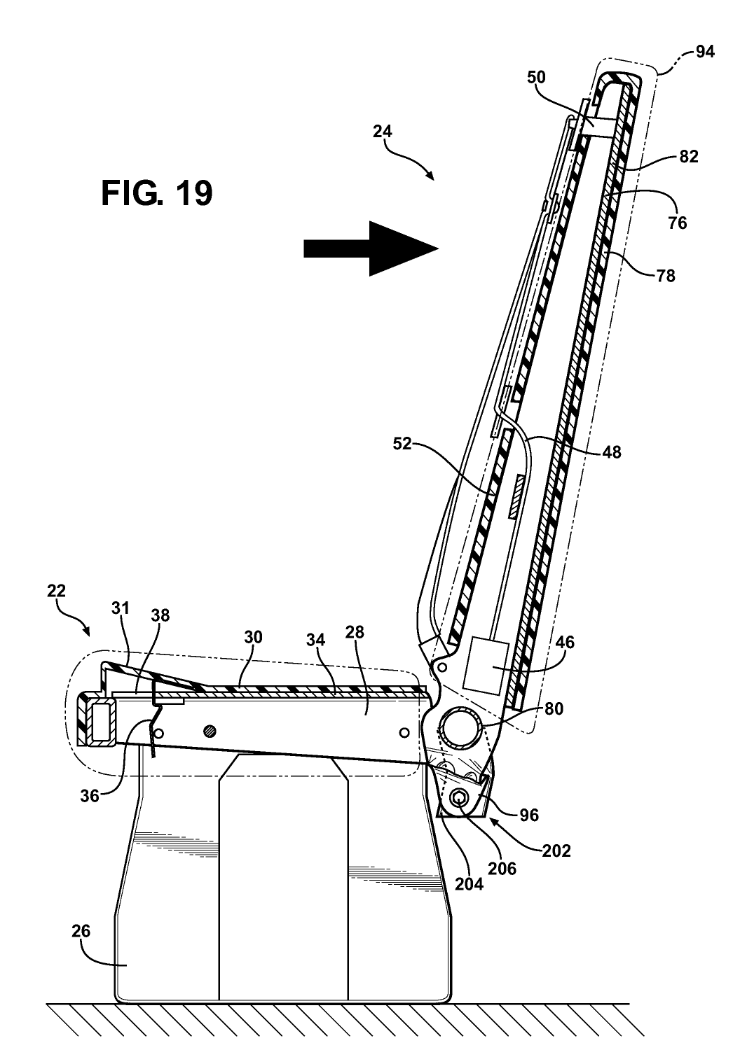

Because the member 204 is fixed to the rod 80 and to the extension 96 and because the rod 80 is fixed to the seat bottom 22, rotation of the seat back 24 relative to the seat bottom 22 in forward and rearward rotation exerts bending forces on the member 204 and the extension 96. At least one of the extension 96 and the member 204 deforms to absorb energy when the seat back 24 rotates in forward and rearward rotation. In FIGS. 16-19, the extension 96 deforms and the member 204 remains undeformed when the seat back 24 rotates in forward and rearward rotation. In FIGS. 18-19, both the extension 96 and the member 204 deform when the seat back 24 rotates in forward and rearward rotation. Alternatively, the member 204 can deform and the extensions 96 can remain undeformed when the seat back 24 rotates in forward and rearward rotation. In any event, the member 204, the extension 96. and the support member 34 also prevent excessive movement of the seat back 24 in forward rotation and rearward rotation.

In FIGS. 16-17, the extension 96 is deformable relative to the member 204. As such, the member 204 remains relatively rigid and undeformed and extension 96 deforms to absorb energy when the seat back 24 rotates in forward rotations and rearward rotation.

In FIGS. 18-19, both the extension 96 and the member 204 can deform in stages. For example, the extension 96 and the member 204 can be designed such that, upon initial rotation of the seat back 24 in forward or rearward rotation, the extension 96 first deforms to absorb energy while the member 204 remains undeformed. If the seat back 24 continues to rotate, the member 204 also deforms to absorb energy. Alternatively, the extension 96 and the member 204 can be designed such that the member 204 initially deforms and the extension 96 subsequently deforms. In any event, the staged deformation allows for both the extension 96 and the member 204 to be tuned to achieve proper energy absorption.

The extension 96 can be configured to absorb a different amount of energy when the seat back 28 rotates based on whether the seat back 28 rotates to the forward position or to the rearward position. As such, the seat assembly 20 can be tuned to absorb the proper amount of energy depending upon the direction of impact to which the seat back 28 is subjected. As set forth below, the energy absorption of the extension 96 can be designed by altering the geometry and material type of the extension 96. The extension 96 can, for example, be configured to bend to absorb a first amount of energy when the seat back 28 rotates to the forward position and can be configured to bend to absorb a second amount of energy when the seat back 28 rotates to the rearward position. Alternatively, the extension 96 can be configured to bend when the seat back 28 rotates to the rearward position and can be configured to be rigid relative to the member 204 when the seat back 28 rotates to the forward position so that the member 204 bends to absorb energy.

As set forth above with reference to the first embodiment, the member 204 and the extension 96 can be designed such that the seat assembly 20 meets the standards set forth in the Federal Motor Vehicle Safety Standards. The energy absorption of the member 104 can be designed and optimized by altering geometry and material type of the member 104. The energy absorption of the extension 96 can also be designed an optimized by altering the geometry and the material type of the extension 96. For example, the extension 96 can define the bend 97 extending along the extension 96 and/or dimples 98 for altering the rigidity of the extension 96. The bend 97 is typically defined between the fastener 114 and the rod 80.

The energy absorbing apparatus 204 of the second embodiment is relatively light-weight, which is advantageous for assembly and for fuel economy of the vehicle. In addition, the energy absorbing apparatus 204 is compact, which is advantageous for packaging of other components of the seat assembly 20, especially below the seat bottom 22.

It should be appreciated that the seat back 24 and seat bottom 22 shown in FIGS. 1-7 with the first and second embodiments of the energy absorbing apparatus 102, 202 are exemplary and that the energy absorbing apparatus 102, 202 can be used with any suitable seat back 24 and seat bottom 22 without departing from the nature of the present invention.

The configuration of the seatbelts in combination with the energy absorbing apparatus 102, 202 and towers 82, 84 cooperate to meet the FMVSS. Generally, the seat 20 is designed to meet the requirements of FMVSS 207 to FMVSS 210, FMVSS 213, FMVSS 222, FMVSS 225, and FMVSS 302. It is to be appreciated that the list of FMVSS requirements met is not an exhaustive list and the seat may meet other safety standards.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A seat assembly for a vehicle, said seat assembly comprising:
a seat bottom;
a seat back coupled to said seat bottom and rotatable in forward rotation relative to said seat bottom from an upright position toward said seat bottom and rotatable in rearward rotation from said upright position in an opposite direction from said forward rotation;
an extension extending from said seat back and spaced from said seat bottom; and
a member coupled to said extension and to said seat bottom for selectively maintaining said seat back in said upright position;
wherein said extension is deformable relative to said member when said seat back rotates in said forward rotation and is rigid relative to said member when said seat back rotates in said rearward rotation so that said extension deforms to absorb energy in said forward rotation and said member deforms to absorb energy in said rearward rotation.

2. The seat assembly as set forth in claim 1 wherein said member is tensioned between said seat bottom and said seat back when said seat back rotates in said forward rotation and wherein said member is compressed between said seat bottom and said seat back when said seat back rotates in said rearward rotation.

3. The seat assembly as set forth in claim 1 wherein said extension defines a bend extending along said extension for altering the rigidity of said extension.

4. The seat assembly as set forth in claim 3 wherein said extension defines dimples along said bend.

5. The seat assembly as set forth in claim 1 wherein said seat back rotates about a rotational axis and wherein said seat back is spaced about said rotational axis from said extension for supporting an occupant seated on said seat bottom.

6. The seat assembly as set forth in claim 5 wherein said seat back and said extension extend along a common axis that intersects said rotational axis.

7. The seat assembly as set forth in claim 5 wherein said seat back extends upwardly relative to said seat bottom and said extension extends downwardly relative to said seat bottom so that forward rotation tensions said member between said seat bottom and said seat back and said rearward rotation compresses said member between said seat bottom and said seat back.

8. The seat assembly as set forth in claim 5 wherein said seat bottom includes a rod that is cylindrical and extends along said rotational axis with said seat back rotatably coupled to said rod.

9. The seat assembly as set forth in claim 8 wherein said seat bottom includes a support member extending transversely to said rod for extending horizontally to support an occupant seated on said seat bottom and wherein said member is pinned to said support member and to said extension.

10. A seat assembly for a vehicle, said seat assembly comprising:
a seat bottom;
a seat back coupled to said seat bottom and rotatable relative to said seat bottom in forward rotation from an upright position toward said seat bottom and in rearward rotation from said upright position in an opposite direction from said forward rotation;
a member coupled to said seat back and to said seat bottom for selectively maintaining said seat back in said upright position;
wherein said seat back is deformable relative to said member when said seat back rotates in said forward rotation and wherein said seat back is rigid relative to said member when said seat back rotates in said rearward rotation so that said seat back deforms to absorb energy in said forward rotation and said member deforms to absorb energy in said rearward rotation.

11. The seat assembly as set forth in claim 10 wherein said member is tensioned between said seat bottom and said seat back when said seat back rotates in said forward rotation and wherein said member is compressed between said seat bottom and said seat back when said seat back rotates in said rearward rotation.

12. The seat assembly as set forth in claim 10 wherein said seat back rotates about a rotational axis and further comprising an extension spaced about said rotational axis from said seat back and wherein said member extends from said extension to said seat bottom.

13. The seat assembly as set forth in claim 12 wherein said seat bottom includes a rod that is cylindrical and extends along said rotational axis with said seat back rotatably coupled to said rod about said rotational axis.

14. The seat assembly as set forth in claim 13 wherein said seat back and said extension extend along a common axis that intersects said rotational axis.

15. The seat assembly as set forth in claim 14 wherein said seat back extends upwardly from said rod and said extension extends downwardly from said rod so that forward rotation tensions said member between said seat bottom and said seat back and said rearward rotation compresses said member between said seat bottom and said seat back.

16. The seat assembly as set forth in claim 13 wherein said seat bottom includes a support member extending transversely to said rod for extending horizontally to support an occupant seated on said seat bottom and wherein said member is pinned to said support member and to said extension.

17. The seat assembly as set forth in claim 12 wherein said extension defines a bend extending along said extension for altering the rigidity of said extension.

18. A seat assembly for a vehicle, said seat assembly comprising:
a seat bottom;
a seat back coupled to said seat bottom and rotatable relative to said seat bottom about a rotational axis in forward rotation from an upright position toward said seat bottom for absorbing energy from an impact of an occupant seated behind the seat back striking the seat back from behind;
an extension fixed relative to said seat back and spaced about said rotational axis from said seat back; and
a member coupled to said extension and to said seat bottom and selectively supporting said seat back in said upright position;
wherein said extension is deformable relative to said member when said seat back rotates in said forward rotation so that said extension deforms to absorb energy in said forward rotation.

19. The seat assembly as set forth in claim 18 wherein said extension defines a bend extending along said extension for altering the rigidity of said extension.

20. The seat assembly as set forth in claim 18 wherein said seat bottom includes a rod extending along said rotational axis with said seat back rotatably coupled to said rod and wherein said seat bottom includes a support member extending transversely to said rod for extending horizontally to support an occupant seated on said seat bottom.

21. The seat assembly as set forth in claim 20 wherein said member extends from said extension to said support member.

22. The seat assembly as set forth in claim 21 wherein said seat back is rotatable relative to said seat bottom in rearward rotation from said upright position in an opposite direction from said forward rotation and wherein said extension is rigid relative to said member when said seat back rotates in said rearward rotation so that said member deforms to absorb energy in said rearward rotation.

23. The seat assembly as set forth in claim 22 wherein said member is tensioned between said seat bottom and said seat back when said seat back rotates in said forward rotation and wherein said member is compressed between said seat bottom and said seat back when said seat back rotates in said rearward rotation.

24. The seat assembly as set forth in claim 18 wherein said seat bottom includes a rod extending along said rotational axis with said seat back rotatably coupled to said rod and wherein said member extends from said extension to said rod.

25. The seat assembly as set forth in claim 24 wherein said seat back is rotatable relative to said seat bottom in rearward rotation from said upright position in an opposite direction from said forward rotation and wherein said extension is deformable relative to said member when said seat back rotates in said rearward rotation so that said extension deforms to absorb energy in said rearward rotation.

26. The seat assembly as set forth in claim 24 wherein said member is fixed to said rod.

27. The seat assembly as set forth in claim 26 wherein said member is pinned to said extension.
